(19) United States
(12) Patent Application Publication
(10) Pub. No.: US 2023/0314178 A1
(43) Pub. Date: Oct. 5, 2023

(54) MAGNETIC ENCODER AND DISTANCE MEASURING DEVICE

(71) Applicant: TDK CORPORATION, Tokyo (JP)

(72) Inventor: Yongfu CAI, Tokyo (JP)

(21) Appl. No.: 18/182,046

(22) Filed: Mar. 10, 2023

(30) Foreign Application Priority Data
Apr. 1, 2022 (JP) 2022-061915

(51) Int. Cl. G01D 5/16; G01S 17/08; G01B 7/30

(52) U.S. Cl. CPC G01D 5/16; G01S 17/08; G01B 7/30

(57) ABSTRACT

A magnetic encoder includes a magnetic field generator configured to generate a target magnetic field including a magnetic field component, and a magnetic sensor configured to detect the target magnetic field. The magnetic sensor includes a plurality of resistors each configured to change in resistance with change in strength of the magnetic field component. The magnetic field generator is a magnetic scale including a plurality of pairs of N and S poles alternately arranged. A magnetic pole pitch being a center-to-center distance between two N poles adjoining via one S pole is different from a design pitch being four times a distance between a predetermined position in one resistor included in the plurality of resistors and a predetermined position in another resistor.

### CROSS REFERENCE TO RELATED APPLICATIONS

This application claims the benefit of Japanese Priority Patent Application No. 2022-061915 filed on Apr. 1, 2022, the entire contents of which are incorporated herein by reference.

### BACKGROUND

The technology relates to a magnetic encoder including a magnetic field generator and a magnetic sensor, and a distance measuring device including the magnetic encoder.

A magnetic encoder using a magnetic sensor is used to detect the position of a movable object whose position changes in a predetermined direction. The predetermined direction is a straight direction or a rotational direction. The magnetic encoder used to detect the position of the movable object is configured such that at least one of a magnetic field generator, such as a magnetic scale, and the magnetic sensor operates depending on the change in the position of the movable object.

When at least one of the magnetic sensor and the magnetic field generator operates, the strength of a component of a target magnetic field, which is generated by the magnetic field generator and applied to the magnetic sensor, in one direction changes. For example, the magnetic sensor detects the strength of the component of the target magnetic field in one direction, and generates two detection signals that correspond to the strength of the component in the one direction and have respective difference phases. The magnetic encoder generates a detection value having a correspondence with the position of the movable object on the basis of the two detection signals.

A magnetic sensor including a plurality of magnetoresistive elements is used as the magnetic sensor for the magnetic encoder. For example, WO 2009/031558 and EP 2267413 A1 disclose a magnetic sensor in which a plurality of giant magnetoresistive (GMR) elements are arranged as the magnetoresistive elements in a direction of relative movement between a magnet and the magnetic sensor and a direction orthogonal to the direction of relative movement.

In the magnetic sensor for the magnetic encoder, a first magnetoresistive element group for generating one detection signal and a second magnetoresistive element group for generating the other detection signal are generally disposed offset in one direction in order to generate two detection signals having phases different from each other. For example, in the magnetic sensor disclosed in EP 2267413 A1, the plurality of GMR elements constitute a phase-A bridge circuit and a phase-B bridge circuit. In the magnetic sensor, the plurality of GMR elements are arranged in the direction of relative movement at center-to-center distances of λ, λ/2, or λ/4, with the center-to-center distance (pitch) of the N and S poles of the magnet as λ. The phase-A bridge circuit and the phase-B bridge circuit produce output waveforms λ/2 different in phase.

As in the magnetic sensor disclosed in EP 2267413 A1, an offset amount between the first magnetoresistive element group and the second magnetoresistive element group has a correspondence with a magnetic pole pitch (for example, a center-to-center distance between two adjoining N poles) of a magnetic field generator to be used. When the magnetic pole pitch is equal or substantially equal to four times the offset amount described above, a harmonic component corresponding to a second-order harmonic included in a detection signal is the smallest. Thus, it is not normally assumed that the magnetic field generator of the magnetic encoder is changed to a magnetic field generator having a different magnetic pole pitch.

However, in the magnetic encoder applied to a device that generates a relatively great vibration, a great distance between the magnetic sensor and the magnetic field generator may be required in order to prevent a collision between the magnetic sensor and the magnetic field generator. When the distance described above is increased without changing a magnetic pole pitch of the magnetic field generator, there is a concern that a magnetic field applied to the magnetic sensor decreases and the detection signal of the magnetic sensor is reduced. Thus, in the case described above, it is desired to use the magnetic field generator having a great magnetic pole pitch. However, since the offset amount described above, i.e., the pitch between the magnetoresistive elements cannot be easily changed, an error of a detection value of the magnetic encoder increases when the magnetic sensor is used in combination with the magnetic field generator having a great magnetic pole pitch while maintaining the pitch between the magnetoresistive elements.

### SUMMARY

A magnetic encoder according to one embodiment of the technology includes a magnetic field generator configured to generate a target magnetic field including a magnetic field component in a first direction, and a magnetic sensor configured to detect the target magnetic field. The magnetic sensor and the magnetic field generator are configured such that strength of the magnetic field component in a reference position changes when at least one of the magnetic sensor and the magnetic field generator operates. The magnetic field generator is a magnetic scale including a plurality of pairs of N and S poles alternately arranged. The magnetic sensor includes a plurality of resistors each configured to change in resistance with change in the strength of the magnetic field component, and is configured to generate a first detection signal and a second detection signal each corresponding to change in the strength of the magnetic field component.

The plurality of resistors include two resistors. A resistance of one resistor of the two resistors has a correspondence with the first detection signal. A resistance of the other resistor of the two resistors has a correspondence with the second detection signal. The one resistor and the other resistor are arranged in positions different from each other in the first direction such that a phase of the first detection signal and a phase of the second detection signal are different from each other. When a magnetic pole pitch refers to a center-to-center distance between two N poles adjoining via one S pole in the magnetic scale, and a design pitch refers to four times a distance between a predetermined position in the one resistor and a predetermined position in the other resistor in the first direction, the magnetic pole pitch is greater than the design pitch.

Each of the first and second detection signals contains an ideal component that varies periodically so as to trace an ideal sinusoidal curve, and a plurality of harmonic components each corresponding to a higher-order harmonic of the ideal component. The plurality of resistors are configured to reduce at least a harmonic component corresponding to a second-order harmonic among the plurality of harmonic components.

In the magnetic encoder according to one embodiment of the technology, the magnetic pole pitch may be greater than 1.1 times the design pitch. The magnetic pole pitch may be greater than 1.25 times the design pitch and smaller than 1.75 times the design pitch.

In the magnetic encoder according to one embodiment of the technology, the magnetic sensor may further include a power supply port, a ground port, a first output port, and a second output port. The plurality of resistors may include a first resistor, a second resistor, a third resistor, a fourth resistor, a fifth resistor, a sixth resistor, a seventh resistor, and an eighth resistor. The first resistor and the second resistor may be provided in this order from the power supply port side in a first path that connects the power supply port and the first output port. The third resistor and the fourth resistor may be provided in this order from the ground port side in a second path that connects the ground port and the first output port. The fifth resistor and the sixth resistor may be provided in this order from the ground port side in a third path that connects the ground port and the second output port. The seventh resistor and the eighth resistor may be provided in this order from the power supply port side in a fourth path that connects the power supply port and the second output port.

A distance between a first position in the first resistor and a second position in the second resistor in the first direction, a distance between a third position in the third resistor and a fourth position in the fourth resistor in the first direction, a distance between a fifth position in the fifth resistor and a sixth position in the sixth resistor in the first direction, and a distance between a seventh position in the seventh resistor and an eighth position in the eighth resistor in the first direction may each be equal to an odd number of times ½ of the design pitch. A distance between the first position and the third position in the first direction and a distance between the fifth position and the seventh position in the first direction may each be equal to zero or an integral number of times of the design pitch. A distance between the first position and the fifth position in the first direction may be equal to ¼ of the design pitch.

The magnetic sensor may further include a plurality of magnetoresistive elements. Each of the plurality of magnetoresistive elements may include a magnetization pinned layer, a free layer, and a gap layer located between the magnetization pinned layer and the free layer. The magnetization pinned layer may have a first magnetization whose direction is fixed. The free layer may have a second magnetization whose direction is variable within a plane parallel to both of the first direction and a second direction orthogonal to the first direction. The magnetization pinned layer, the free layer, and the gap layer may be stacked in a third direction orthogonal to the first direction and the second direction. The first to eighth resistors may be formed of the plurality of magnetoresistive elements. The first magnetization of the magnetization pinned layer in the first, fourth, sixth, and seventh resistors may contain a component in a first magnetization direction being one direction parallel to the first direction. The first magnetization of the magnetization pinned layer in the second, third, fifth, and eighth resistors may contain a component in a second magnetization direction opposite to the first magnetization direction.

When the plurality of resistors include the first to eighth resistors, the first position may be a center of gravity of the first resistor when viewed in one direction parallel to the third direction. The second position may be a center of gravity of the second resistor when viewed in one direction parallel to the third direction. The third position may be a center of gravity of the third resistor when viewed in one direction parallel to the third direction. The fourth position may be a center of gravity of the fourth resistor when viewed in one direction parallel to the third direction. The fifth position may be a center of gravity of the fifth resistor when viewed in one direction parallel to the third direction. The sixth position may be a center of gravity of the sixth resistor when viewed in one direction parallel to the third direction. The seventh position may be a center of gravity of the seventh resistor when viewed in one direction parallel to the third direction. The eighth position may be a center of gravity of the eighth resistor when viewed in one direction parallel to the third direction.

When the plurality of resistors include the first to eighth resistors, the first resistor and the third resistor may adjoin in the second direction. The second resistor and the fourth resistor may adjoin in the second direction. The fifth resistor and the seventh resistor may adjoin in the second direction. The sixth resistor and the eighth resistor may adjoin in the second direction.

When the plurality of resistors include the first to eighth resistors, the first resistor may adjoin to the seventh resistor and may not adjoin to the eighth resistor. The eighth resistor may adjoin to the second resistor and may not adjoin to the first resistor. The third resistor may be located at a position such that the first resistor is sandwiched between the third resistor and the seventh resistor. The fourth resistor may be located at a position such that the second resistor is sandwiched between the fourth resistor and the eighth resistor. The fifth resistor may be located at a position such that the seventh resistor is sandwiched between the fifth resistor and the first resistor. The sixth resistor may be located at a position such that the eighth resistor is sandwiched between the sixth resistor and the second resistor.

When the magnetic sensor includes the plurality of magnetoresistive elements, each of the plurality of magnetoresistive elements may be configured such that a bias magnetic field in a direction intersecting the first direction is applied to the free layer. The gap layer may be a tunnel barrier layer.

In the magnetic encoder according to one embodiment of the technology, the magnetic field generator may be configured to rotate about a rotation axis, and may include an end surface located at an end in one direction parallel to the rotation axis. The plurality of pairs of N and S poles may be alternately arranged around the rotation axis, and may be provided on the end surface. The strength of the magnetic field component in the reference position may change according to rotation of the magnetic field generator. The magnetic sensor may be located to face the end surface. The magnetic field generator may be configured to rotate in conjunction with an optical element configured to change a traveling direction of light for measuring a distance to a target object.

In the magnetic encoder according to one embodiment of the technology, the magnetic field generator may be configured to rotate about a rotation axis, and may include an outer circumferential surface directed to a direction away from the rotation axis. The plurality of pairs of N and S poles may be alternately arranged around the rotation axis, and may be provided on the outer circumferential surface. The strength of the magnetic field component in the reference position may change according to rotation of the magnetic field generator. The magnetic sensor may be located to face the outer circumferential surface. The magnetic field generator may be configured to rotate in conjunction with an optical element configured to change a traveling direction of light for measuring a distance to a target object.

A distance measuring device according to one embodiment of the technology is a distance measuring device for measuring a distance to a target object by detecting applied light. The distance measuring device includes an optical element configured to rotate together when a traveling direction of the light changes, and the magnetic encoder according to one embodiment of the technology. The magnetic field generator is configured to rotate about a rotation axis in conjunction with the optical element. The plurality of pairs of N and S poles are alternately arranged around the rotation axis. The strength of the magnetic field component in the reference position changes according to rotation of the magnetic field generator.

In the distance measuring device according to one embodiment of the technology, the magnetic field generator may include an end surface located at an end in one direction parallel to the rotation axis. In this case, the plurality of pairs of N and S poles may be provided on the end surface. The magnetic sensor may be located to face the end surface. Alternatively, the magnetic field generator may include an outer circumferential surface directed to a direction away from the rotation axis. In this case, the plurality of pairs of N and S poles may be provided on the outer circumferential surface. The magnetic sensor may be located to face the outer circumferential surface.

In the magnetic encoder and the distance measuring device according to one embodiment of the technology, the plurality of resistors are configured to reduce at least a harmonic component corresponding to a second-order harmonic among the plurality of harmonic components. In this way, according to one embodiment of the technology, an error due to a difference in a magnetic pole pitch of a magnetic field generator can be reduced.

Other and further objects, features and advantages of the technology will appear more fully from the following description.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a perspective view showing a distance measuring device according to an example embodiment of the technology.

FIG. 2 is a perspective view showing a magnetic encoder according to the example embodiment of the technology.

FIG. 3 is a plan view showing the magnetic encoder according to the example embodiment of the technology.

FIG. 4 is a front view showing the magnetic encoder according to the example embodiment of the technology.

FIG. 5 is a plan view showing a magnetic sensor according to the example embodiment of the technology.

FIG. 6 is a circuit diagram showing a configuration of the magnetic sensor according to the example embodiment of the technology.

FIG. 7 is an explanatory diagram for describing a layout of first to eighth resistors of the example embodiment of the technology.

FIG. 8 is a plan view showing the first resistor of the example embodiment of the technology.

FIG. 9 is a perspective view showing a first example of a magnetoresistive element of the example embodiment of the technology.

FIG. 10 is a perspective view showing a second example of the magnetoresistive element of the example embodiment of the technology.

FIG. 11 is a plan view showing a magnetic sensor of a comparative example.

FIG. 12 is a circuit diagram showing a configuration of the magnetic sensor of the comparative example.

FIG. 13 is a characteristic chart showing an amplitude ratio of a model of the comparative example determined by a simulation.

FIG. 14 is a characteristic chart showing an amplitude ratio of a model of a practical example determined by the simulation.

FIG. 15 is a characteristic chart showing an error of a detection value of each of the model of the comparative example and the model of the practical example determined by the simulation.

FIG. 16 is a perspective view showing a magnetic field generator in a modification example of the magnetic encoder according to the example embodiment of the technology.

### DETAILED DESCRIPTION

An object of the technology is to provide a magnetic encoder that can reduce an error due to a difference in a magnetic pole pitch of a magnetic field generator, and a distance measuring device including the magnetic encoder.

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions. Note that the description is given in the following order.

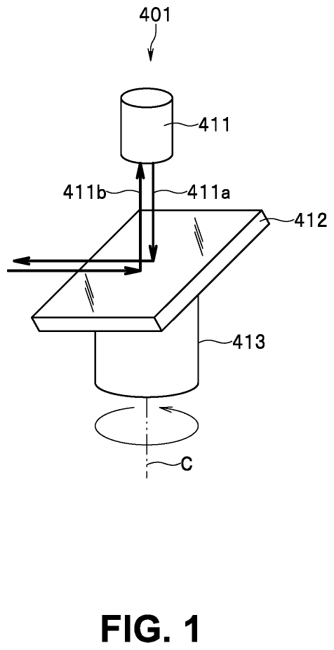

First, a distance measuring device according to the present example embodiment will be described with reference to FIG. 1. FIG. 1 is a perspective view showing a distance measuring device 401 according to the present example embodiment.

A distance measuring device 401 shown in FIG. 1 is a device that measures a distance to a target object by detecting applied light, and constitutes, for example, a part of light detection and ranging (LIDAR) for automotive use. In the example shown in FIG. 1, the distance measuring device 401 includes a photoelectric unit 411, an optical element 412, and a not-shown driving unit.

The photoelectric unit 411 includes an optical element that applies light 411a, and a detection element that detects reflected light 411b from a target object. The optical element 412 may be, for example, a mirror supported by a support 413. The optical element 412 is inclined with respect to an emission surface of the optical element such that a traveling direction of each of the light 411a and the reflected light 411b is changed. The optical element 412 is configured to rotate about a predetermined rotation axis by the not-shown driving unit.

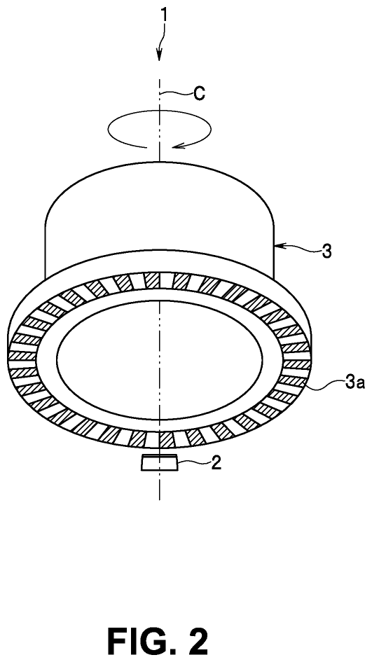

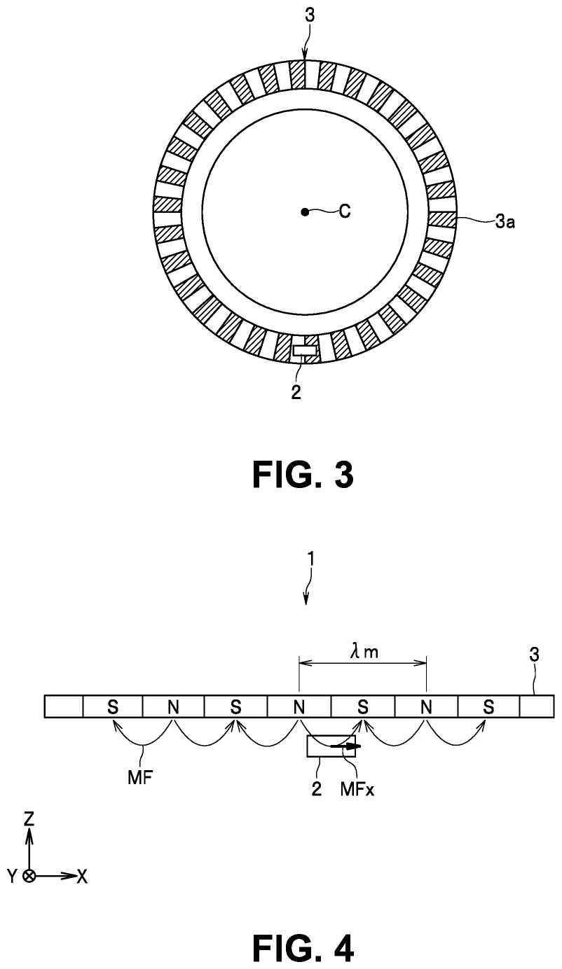

A magnetic encoder 1 according to the present example embodiment is used as a position detection device for detecting a rotation position of the optical element 412. A schematic configuration of the magnetic encoder 1 will be described below with reference to FIGS. 2 to 4. FIG. 2 is a perspective view showing the magnetic encoder 1. FIG. 3 is a plan view showing the magnetic encoder 1. FIG. 4 is a front view showing the magnetic encoder 1.

The magnetic encoder 1 according to the present example embodiment includes a magnetic sensor 2 and a magnetic field generator 3. The magnetic field generator 3 is configured to rotate about a rotation axis C in conjunction with the optical element 412 illustrated in FIG. 1.

The magnetic field generator 3 generates a target magnetic field MF that is a magnetic field for position detection and a magnetic field for the magnetic sensor 2 to detect (magnetic field to be detected). The target magnetic field MF includes a magnetic field component in a direction parallel to an imaginary straight line. The magnetic sensor 2 and the magnetic field generator 3 are configured such that the strength of the magnetic field component in a reference position changes when at least one of the magnetic sensor 2 and the magnetic field generator 3 operates. The reference position may be a position in which the magnetic sensor 2 is located. The magnetic sensor 2 detects the target magnetic field MF including the magnetic field component described above, and generates first and second detection signals each corresponding to the strength of the magnetic field component.

In particular, in the present example embodiment, the magnetic field generator 3 is a magnetic scale (rotation scale) including a plurality of pairs of N and S poles alternately arranged around the rotation axis C. The magnetic field generator 3 includes an end surface 3a located at an end in one direction parallel to the rotation axis C. The plurality of pairs of N and S poles are provided on the end surface 3a. In FIGS. 2 and 3, for ease of understanding, the N pole is shown with hatching. In FIG. 4, for ease of understanding, the magnetic field generator 3 is schematically illustrated with the plurality of pairs of N poles and S poles. The magnetic sensor 2 is located so as to face the end surface 3a. The strength of a magnetic field component MFx in a reference position, for example, a position in which the magnetic sensor 2 is located changes according to rotation of the magnetic field generator 3.

As shown in FIG. 4, a distance between two N poles adjoining in the rotational direction of the magnetic field generator 3, in other words, a center-to-center distance between the two N poles adjoining via one S pole will be referred to as a magnetic pole pitch. The size of the magnetic pole pitch will be denoted by the symbol km. A center-to-center distance between two S poles adjoining via one N pole is equal to the magnetic pole pitch λm.

Now, X, Y, and Z directions are defined as shown in FIG. 4. In the present example embodiment, two directions orthogonal to the rotation axis C may be the X direction and the Y direction, and a direction parallel to the rotation axis C and directed from the magnetic sensor 2 to the magnetic field generator 3 is the Z direction. The Y direction is a direction from the magnetic sensor 2 to the rotation axis C. In FIG. 4, the Y direction is shown as a direction from the near side to the far side of FIG. 4. The opposite directions to the X, Y, and Z directions will be referred to as −X, −Y, and −Z directions, respectively.

The magnetic sensor 2 is located away from the magnetic field generator 3 in the −Z direction. The magnetic sensor 2 is configured to be able to detect the strength of a magnetic field component MFx of the target magnetic field MF at a predetermined position in a direction parallel to the X direction. For example, the strength of the magnetic field component MFx is expressed in positive values if the direction of the magnetic field component MFx is the X direction, and in negative values if the direction of the magnetic field component MFx is the −X direction. The strength of the magnetic field component MFx changes periodically as the magnetic field generator 3 rotates. The direction parallel to the X direction corresponds to a “first direction” in the technology.

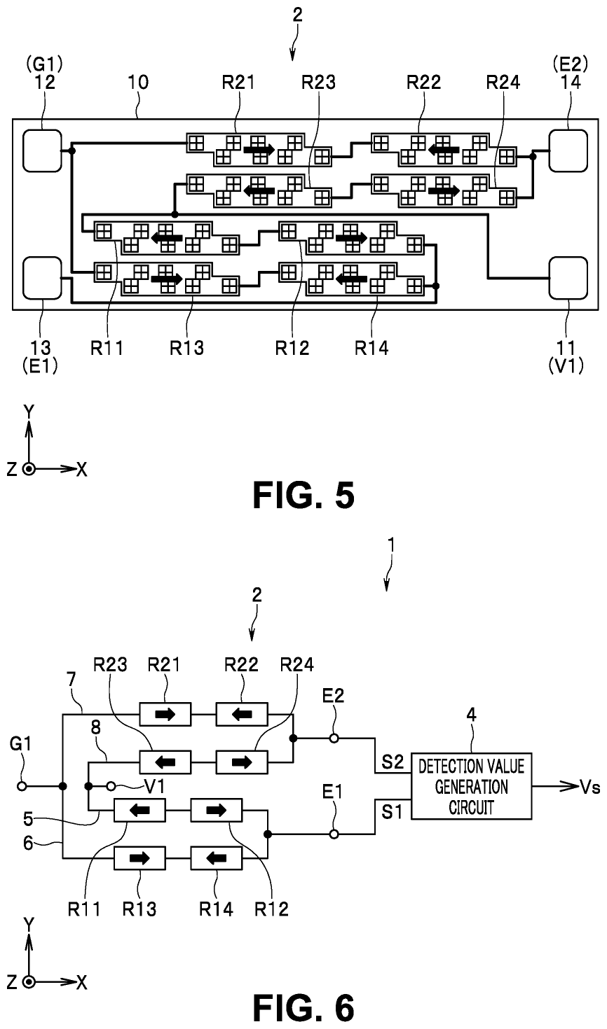

Next, the magnetic sensor 2 will be described in detail with reference to FIGS. 5 and 6. FIG. 5 is a plan view showing the magnetic sensor 2. FIG. 6 is a circuit diagram showing a configuration of the magnetic sensor 2. As shown in FIG. 6, the magnetic encoder 1 further includes a detection value generation circuit 4. The detection value generation circuit 4 generates a detection value Vs having a correspondence with the rotation position of the magnetic field generator 3, i.e., the rotation position of the optical element 412 on the basis of a first detection signal S1 and a second detection signal S2 corresponding to the strength of the magnetic field component MFx and generated by the magnetic sensor 2. The detection value generation circuit 4 can be implemented by an application specific integrated circuit (ASIC) or a microcomputer, for example.

The magnetic sensor 2 includes a first resistor R11, a second resistor R12, a third resistor R13, a fourth resistor R14, a fifth resistor R21, a sixth resistor R22, a seventh resistor R23, and an eighth resistor R24 each configured to change in resistance with the strength of the magnetic field component MFx. The magnetic sensor 2 includes a plurality of magnetoresistive elements (hereinafter, referred to as MR elements) 50. Each of the first to eighth resistors R11 to R14 and R21 to R24 is formed of the plurality of MR elements 50.

The magnetic sensor 2 further includes a power supply port V1, a ground port G1, a first output port E1, and a second output port E2. The ground port G1 is connected to the ground. The first and second output ports E1 and E2 are connected to the detection value generation circuit 4. The magnetic sensor 2 may be driven by a constant voltage or driven by a constant current. In the case where the magnetic sensor 2 is driven by a constant voltage, a voltage of predetermined magnitude is applied to the power supply port V1. In the case where the magnetic sensor 2 is driven by a constant current, a current of predetermined magnitude is supplied to the power supply port V1.

The magnetic sensor 2 generates a signal having a correspondence with the potential at the first output port E1 as a first detection signal S1, and generates a signal having a correspondence with the potential at the second output port E2 as a second detection signal S2. The detection value generation circuit 4 generates the detection value Vs on the basis of the first and second detection signals S1 and S2. At least either the magnetic sensor 2 or the detection value generation circuit 4 may be configured to be able to correct the amplitude, phase, and offset of each of the first and second detection signals S1 and S2.

The first to eighth resistors R11 to R14 and R21 to R24 satisfy the following requirement about the layout in a circuit configuration. The first resistor R11 and the second resistor R12 are provided in this order from the power supply port V1 side in a first path 5 that connects the power supply port V1 and the first output port E1. The third resistor R13 and the fourth resistor R14 are provided in this order from the ground port G1 side in a second path 6 that connects the ground port G1 and the first output port E1. The fifth resistor R21 and the sixth resistor R22 are provided in this order from the ground port G1 side in a third path 7 that connects the ground port G1 and the second output port E2. The seventh resistor R23 and the eighth resistor R24 are provided in this order from the power supply port V1 side in a fourth path 8 that connects the power supply port V1 and the second output port E2.

As shown in FIG. 5, the magnetic sensor 2 further includes a substrate 10, and a power supply terminal 11, a ground terminal 12, a first output terminal 13, and a second output terminal 14 that are located on the substrate 10. The power supply terminal 11 constitutes the power supply port V1. The ground terminal 12 constitutes the ground port G1. The first and second output terminals 13 and 14 constitute the first and second output ports E1 and E2, respectively.

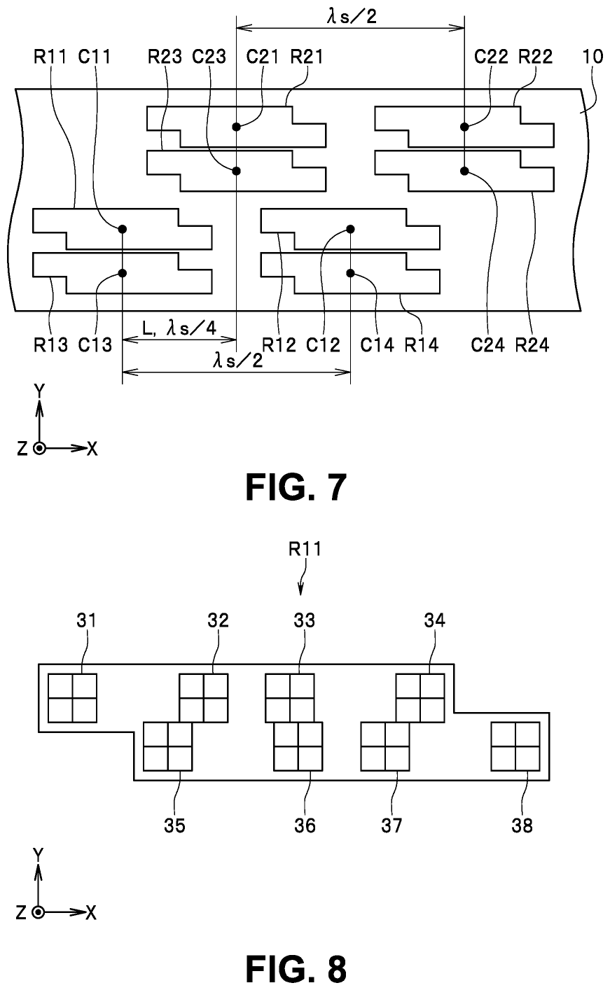

Next, the layout of the first to eighth resistors R11 to R14 and R21 to R24 will be described with reference to FIG. 7. FIG. 7 is an explanatory diagram for describing the layout of the first to eighth resistors R11 to R14 and R21 to R24. A resistance of each of the first to fourth resistors R11 to R14 has correspondence with the first detection signal S1. A resistance of each of the fifth to eighth resistors R21 to R24 has a correspondence with the second detection signal S2. A group of the first to fourth resistors R11 to R14 and a group of the fifth to eighth resistors R21 to R24 are arranged in positions different from each other in the direction parallel to the X direction such that a phase of the first detection signal S1 and a phase of the second detection signal S2 are different from each other.

In FIG. 7, a reference numeral C11 denotes a first position inside the first resistor R11, a reference numeral C12 denotes a second position inside the second resistor R12, a reference numeral C13 denotes a third position inside the third resistor R13, and a reference numeral C14 denotes a fourth position inside the fourth resistor R14. The first to fourth positions C11 to C14 are positions for determining physical positions of the first to fourth resistors R11 to R14, respectively. In particular, in the present example embodiment, the first position C11 is the center of gravity of the first resistor R11 when viewed in the Z direction, in other words, when the magnetic sensor 2 is viewed from a position in front of the magnetic sensor 2 in the Z direction. The second position C12 is the center of gravity of the second resistor R12 when viewed in the Z direction, the third position C13 is the center of gravity of the third resistor R13 when viewed in the Z direction, and the fourth position C14 is the center of gravity of the fourth resistor R14 when viewed in the Z direction.

In FIG. 7, a reference numeral C21 denotes a fifth position inside the fifth resistor R21, a reference numeral C22 denotes a sixth position inside the sixth resistor R22, a reference numeral C23 denotes a seventh position inside the seventh resistor R23, and a reference numeral C24 denotes an eighth position inside the eighth resistor R24. The fifth to eighth positions C21 to C24 are positions for determining physical positions of the fifth to eighth resistors R21 to R24, respectively. In particular, in the present example embodiment, the fifth position C21 is the center of gravity of the fifth resistor R21 when viewed in the Z direction, the sixth position C22 is the center of gravity of the sixth resistor R22 when viewed in the Z direction, the seventh position C23 is the center of gravity of the seventh resistor R23 when viewed in the Z direction, and the eighth position C24 is the center of gravity of the eighth resistor R24 when viewed in the Z direction.

Now, a design pitch λs is defined as described below. The design pitch λs is four times a distance between a predetermined position in the first resistor R11 and a predetermined position in the fifth resistor R21 in the direction parallel to the X direction. In particular, in the present example embodiment, the predetermined position in the first resistor R11 is the first position C11, and the predetermined position in the fifth resistor R21 is the fifth position C21.

In particular, in the present example embodiment, a distance between the first position C11 and the fifth position C21 in the direction parallel to the X direction, a distance between the second position C12 and the sixth position C22 in the direction parallel to the X direction, a distance between the third position C13 and the seventh position C23 in the direction parallel to the X direction, and a distance between the fourth position C14 and the eighth position C24 in the direction parallel to the X direction are equal to one another. Therefore, the design pitch λs can also be defined by using a pair of the second and sixth resistors R12 and R22, a pair of the third and seventh resistors R13 and R23, or a pair of the fourth and eighth resistors R14 and R24 instead of a pair of the first and fifth resistors R11 and R21.

The magnetic pole pitch λm shown in FIG. 4 is greater than the design pitch λs. The magnetic pole pitch λm is preferably greater than 1.1 times the design pitch λs, greater than 1.25 times the design pitch λs, and smaller than 1.75 times the design pitch λs.

Now, assume an imaginary magnetic field generator different from the magnetic field generator 3 in the present example embodiment. The configuration of the imaginary magnetic field generator is the same as the configuration of the magnetic field generator 3 except for a point that a magnetic pole pitch is different from the magnetic pole pitch λm of the magnetic field generator 3. The magnetic pole pitch of the imaginary magnetic field generator is equal to the design pitch λs. Therefore, the magnetic pole pitch λm is greater than the magnetic pole pitch of the imaginary magnetic field generator. When the magnetic field generator 3 is replaced with the imaginary magnetic field generator, a phase difference between the first detection signal S1 and the second detection signal S2 is 90°. When the magnetic field generator 3 is replaced with the imaginary magnetic field generator, a group of the first to fourth resistors R11 to R14 and a group of the fifth to eighth resistors R21 to R24 are arranged in positions different from each other in the direction parallel to the X direction such that the phase difference between the first detection signal S1 and the second detection signal S2 is 90°.

The first to eighth resistors R11 to R14 and R21 to R24 satisfy the following requirement about the physical layout. A distance between the first position C11 and the second position C12 in the direction parallel to the X direction, a distance between the third position C13 and the fourth position C14 in the direction parallel to the X direction, a distance between the fifth position C21 and the sixth position C22 in the direction parallel to the X direction, and a distance between the seventh position C23 and the eighth position C24 in the direction parallel to the X direction are equal to an odd number of times ½ of the design pitch λs. A distance between the first position C11 and the third position C13 in the direction parallel to the X direction and a distance between the fifth position C21 and the seventh position C23 in the direction parallel to the X direction are each equal to zero or an integral number of times of the design pitch λs. A distance between the first position C11 and the fifth position C21 in the direction parallel to the X direction is equal to ¼ of the design pitch λs.

In the present example embodiment, the second position C12 is a position λs/2 away from the first position C11 in the X direction, and the fourth position C14 is a position λs/2 away from the third position C13 in the X direction. The distance between the first position C11 and the third position C13 in the direction parallel to the X direction is zero. In other words, the third position C13 in the direction parallel to the X direction is the same as the first position C11 in the same direction. The third position C13 is located in front of the first position C11 in the −Y direction. The fourth position C14 in the direction parallel to the X direction is the same as the second position C12 in the same direction. The fourth position C14 is located in front of the second position C12 in the —Y direction.

The fifth to eighth resistors R21 to R24 are located in front of the first to fourth resistors R11 to R14 in the Y direction. The physical layout of the fifth to eighth resistors R21 to R24 is similar to the physical layout of the first to fourth resistors R11 to R14. When the first to fourth resistors R11 to R14 and the first to fourth positions C11 to C14 in the description of the physical layout of the first to fourth resistors R11 to R14 are replaced by the fifth to eighth resistors R21 to R24 and the fifth to eighth positions C21 to C24, respectively, this corresponds to the description of the physical layout of the fifth to eighth resistors R21 to R24.

In the present example embodiment, the fifth position C21 (seventh position C23) is located λs/4 in front of the first position C11 (third position C13) in the X direction. The sixth position C22 (eighth position C24) is located λs/4 in front of the second position C12 (fourth position C14) in the X direction.

The first resistor R11 adjoins to the seventh resistor R23, but does not adjoin to the eighth resistor R24. The eighth resistor R24 adjoins to the second resistor R12, but does not adjoin to the first resistor R11.

The third resistor R13 is located at a position such that the first resistor R11 is sandwiched between the third resistor R13 and the seventh resistor R23. The fourth resistor R14 is located at a position such that the second resistor R12 is sandwiched between the fourth resistor R14 and the eighth resistor R24. The fifth resistor R21 is located at a position such that the seventh resistor R23 is sandwiched between the fifth resistor R21 and the first resistor R11. The sixth resistor R22 is located at a position such that the eighth resistor R24 is sandwiched between the sixth resistor R22 and the second resistor R12.

Next, a configuration of the first to eighth resistors R11 to R14 and R21 to R24 will be described. Each of the first and second detection signals S1 and S2 contains an ideal component which varies periodically with a predetermined signal period in such a manner as to trace an ideal sinusoidal curve (including sine and cosine waveforms). In the present example embodiment, the first to eighth resistors R11 to R14 and R21 to R24 are configured such that the ideal component of the first detection signal S1 and the ideal component of the second detection signal S2 have respective different phases. The design pitch λs shown in FIG. 7 corresponds to one period of the ideal component when the imaginary magnetic field generator described above is used, i.e., an electrical angle of 360°. In the magnetic encoder 1 according to the present example embodiment, the magnetic field generator 3 having a magnetic pole pitch of km is used. When the magnetic field generator 3 is used, the magnetic pole pitch λm corresponds to one period of the ideal component (an electrical angle of 360°). In other words, a period of the ideal component is λm.

Each of the first and second detection signals S1 and S2 contains a plurality of harmonic components corresponding to higher-order harmonics of the ideal component aside from the ideal component. In the present example embodiment, the first to eighth resistors R11 to R14 and R21 to R24 are configured to reduce the plurality of harmonic components.

The configuration of the first to eighth resistors R11 to R14 and R21 to R24 will be described in detail below. Initially, the configuration of the MR elements 50 will be described. In the present example embodiment, the MR elements 50 are each a spin-valve MR element. The spin-valve MR element includes a magnetization pinned layer, a free layer, and a gap layer located between the magnetization pinned layer and the free layer. The magnetization pinned layer has a first magnetization whose direction is fixed. The free layer has a second magnetization whose direction is variable within a plane (within an XY plane) parallel to both of the direction parallel to the X direction and a direction parallel to the Y direction. The magnetization pinned layer, the free layer, and the gap layer are stacked in a direction parallel to the Z direction. The direction parallel to the Y direction corresponds to a “second direction” in the technology. The direction parallel to the Z direction corresponds to a “third direction” in the technology.

The spin-valve MR element may be a tunneling magnetoresistive (TMR) element or a giant magnetoresistive (GMR) element. In particular, in the present example embodiment, the MR element 50 is desirably a TMR element to reduce the dimensions of the magnetic sensor 2. In the TMR element, the gap layer is a tunnel barrier layer. In the GMR element, the gap layer is a nonmagnetic conductive layer. The resistance of the spin-valve MR element changes with the angle that the magnetization direction of the free layer forms with respect to the magnetization direction of the magnetization pinned layer. The resistance of the spin-valve MR element is at its minimum value when the foregoing angle is 0°, and at its maximum value when the foregoing angle is 180°.

In FIGS. 5 and 6, arrows shown inside the first to eighth resistors R11 to R14 and R21 to R24 indicate first magnetization directions of the magnetization pinned layers in the respective plurality of MR elements 50 included in the resistors.

The first to eighth resistors R11 to R14 and R21 to R24 satisfy the following requirement about the magnetization of the magnetization pinned layer. The first magnetization of the magnetization pinned layer in the first and fourth resistors R11 and R14 contains a component in a first magnetization direction being one direction parallel to the above-described first direction (the direction parallel to the X direction). The first magnetization of the magnetization pinned layer in the second and third resistors R12 and R13 contains a component in a second magnetization direction opposite to the first magnetization direction. The first magnetization of the magnetization pinned layer in the fifth and eighth resistors R21 and R24 contains the component in the second magnetization direction. The first magnetization of the magnetization pinned layer in the sixth and seventh resistors R22 and R23 contains the component in the first magnetization direction. In particular, in the present example embodiment, the first magnetization direction is the −X direction, and the second magnetization direction is the X direction.

Note that, when the first magnetization contains a component in a specific magnetization direction, the component in the specific magnetization direction may be a main component of the first magnetization. Alternatively, the first magnetization may not contain a component in a direction orthogonal to the specific magnetization direction. In the present example embodiment, when the first magnetization contains the component in the specific magnetization direction, the first magnetization direction is the specific magnetization direction or substantially the specific magnetization direction.

The second magnetization directions of the free layers in the respective plurality of MR elements 50 change within the XY plane with the strength of the magnetic field component MFx. Consequently, the potential at each of the first and second output ports E1 and E2 changes with the strength of the magnetic field component MFx.

Next, the layout of the plurality of MR elements 50 in each of the first to eighth resistors R11 to R14 and R21 to R24 will be described. As employed herein, a set of one or more MR elements 50 will be referred to as an element group. Each of the first to eighth resistors R11 to R14 and R21 to R24 includes a plurality of the element groups. To reduce an error component, the plurality of element groups are located at predetermined distances from each other on the basis of the design pitch λs. In the following description, the layout of the plurality of element groups will be described with reference to predetermined positions of the element groups. An example of the predetermined position of an element group is the center of gravity of the element group when viewed in the Z direction.

FIG. 8 is a plan view showing the first resistor R11. As shown in FIG. 8, the first resistor R11 includes eight element groups 31, 32, 33, 34, 35, 36, 37, and 38. Each of the element groups 31 to 38 is divided into four sections. Each section includes one or more MR elements 50. In other words, each element group includes four or more MR elements 50. The plurality of MR elements 50 may be connected in series within each element group. In such a case, the plurality of element groups may be connected in series. Alternatively, the plurality of MR elements 50 may be connected in series regardless of the element groups.

In FIG. 8, when the imaginary magnetic field generator described above is used, the element groups 31 to 38 are located to reduce a harmonic component corresponding to a third harmonic (third-order harmonic) of the ideal component, a harmonic component corresponding to a fifth harmonic (fifth-order harmonic) of the ideal component, and a harmonic component corresponding to a seventh harmonic (seventh-order harmonic) of the ideal component. As shown in FIG. 8, the element groups 31 to 34 are arranged along the X direction. The element group 32 is located at a position λs/10 away from the element group 31 in the X direction. The element group 33 is located at a position λs/6 away from the element group 31 in the X direction. The element group 34 is located at a position λs/10+λs/6 away from the element group 31 in the X direction (at a position λs/6 away from the element group 32 in the X direction).

As shown in FIG. 8, the element groups 35 to 38 are arranged along the X direction, in front of the element groups 31 to 34 in the −Y direction. The element group 35 is located at a position λs/14 away from the element group 31 in the X direction. The element group 36 is located at a position λs/14+λs/10 away from the element group 31 in the X direction (at a position λs/14 away from the element group 32 in the X direction). The element group 37 is located at a position λs/14+λs/6 away from the element group 31 in the X direction (at a position λs/14 away from the element group 33 in the X direction). The element group 38 is located at a position λs/14+λs/10+λs/6 away from the element group 31 in the X direction (at a position λs/14 away from the element group 34 in the X direction).

The layout of the plurality of element groups for reducing the plurality of harmonic components is not limited to the example shown in FIG. 8. Suppose now that k and m are integers that are greater than or equal to 1 and different from each other. For example, to reduce a harmonic component corresponding to a (2k+1)th-order harmonic, a first element group is located at a position λs/(4k+2) away from a second element group in the X direction. Further, to reduce an error component corresponding to a (2 m+1)th-order harmonic, a third element group is located at a position λs/(4 m+2) away from the first element group in the X direction, and a fourth element group is located at a position λs/(4 m+2) away from the second element group in the X direction. In such a manner, to reduce harmonic components corresponding to a plurality of harmonics, each of a plurality of element groups for reducing an error component corresponding to one harmonic is located at a position a predetermined distance based on the design pitch λs away from a corresponding one of a plurality of element groups for reducing an error component corresponding to another harmonic in the X direction.

In the present example embodiment, the configuration and layout of the plurality of element groups in each of the second to eighth resistors R12 to R14 and R21 to R24 are the same as those of the plurality of element groups in the first resistor R11. More specifically, each of the second to eighth resistors R12 to R14 and R21 to R24 also includes the eight element groups 31 to 38 having the configuration and positional relationship shown in FIG. 8. Note that the element group 31 of the third resistor R13 is located at the same position as the element group 31 of the first resistor R11 is in the X direction. The element group 31 of the fourth resistor R14 is located at the same position as the element group 31 of the second resistor R12 is in the X direction. The element group 31 of the second resistor R12 is located at a position λs/2 away from the element group 31 of the first resistor R11 in the X direction. The element group 31 of the fourth resistor R14 is located at a position λs/2 away from the element group 31 of the third resistor R13 in the X direction.

The element group 31 of the seventh resistor R23 is located at the same position as the element group 31 of the fifth resistor R21 is in the X direction. The element group 31 of the eighth resistor R24 is located at the same position as the element group 31 of the sixth resistor R22 is in the X direction. The element group 31 of the fifth resistor R21 is located at a position λs/4 away from the element group 31 of the first resistor R11 in the X direction. The element group 31 of the sixth resistor R22 is located at a position λs/2 away from the element group 31 of the fifth resistor R21 in the X direction. The element group 31 of the eighth resistor R24 is located at a position λs/2 away from the element group 31 of the seventh resistor R23 in the X direction.

The configuration of the first to eighth resistors R11 to R14 and R21 to R24 described above makes a phase difference of the ideal component of the second detection signal S2 from the ideal component of the first detection signal S1 an odd number of times ¼ of a predetermined signal period (the signal period of the ideal component), and reduces the plurality of harmonic components of the respective first and second detection signals S1 and S2.

Note that, in the light of the production accuracy of the MR elements 50 and other factors, the positions of the first to eighth resistors R11 to R14 and R21 to R24 and the positions of the element groups 31 to 38 may be slightly different from the above-described positions.

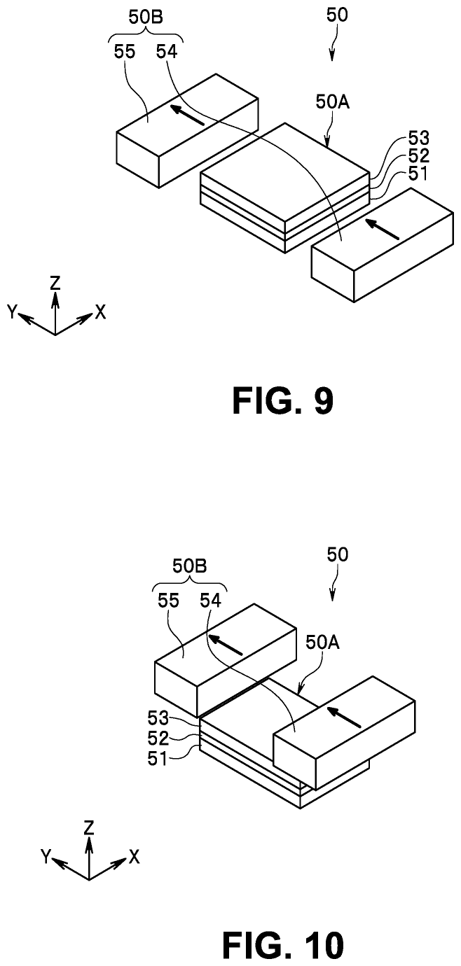

Next, first and second examples of the MR element 50 will be described with reference to FIGS. 9 and 10. FIG. 9 is a perspective view showing the first example of the MR element 50. In the first example, the MR element 50 includes a layered film 50A including a magnetization pinned layer 51, a gap layer 52, and a free layer 53 stacked in this order in the Z direction. The layered film 50A may have a circular planar shape, or a square or almost square planar shape as shown in FIG. 9 when viewed in the Z direction.

The bottom surface of the layered film 50A of the MR element 50 is electrically connected to the bottom surface of the layered film 50A of another MR element 50 by a not-shown lower electrode. The top surface of the layered film 50A of the MR element 50 is electrically connected to the top surface of the layered film 50A of yet another MR element 50 by a not-shown upper electrode. In such a manner, the plurality of MR elements 50 are connected in series. It should be appreciated that the layers 51 to 53 of each layered film 50A may be stacked in the reverse order to that shown in FIG. 9.

The MR element 50 further includes a bias magnetic field generator 50B that generates a bias magnetic field to be applied to the free layer 53. The direction of the bias magnetic field intersects the direction parallel to the X direction. In the first example, the bias magnetic field generator 50B includes two magnets 54 and 55. The magnet 54 is located in front of the layered film 50A in the −Y direction. The magnet 55 is located in front of the layered film 50A in the Y direction. In particular, in the first example, the layered film 50A and the magnets 54 and 55 are located at positions to intersect an imaginary plane parallel to the XY plane. In FIG. 9, the arrows in the magnets 54 and 55 indicate the magnetization directions of the magnets 54 and 55. In the first example, the direction of the bias magnetic field is the Y direction.

FIG. 10 is a perspective view showing the second example of the MR element 50. The second example of the MR element 50 has the same configuration as that of the first example of the MR element 50 except the planar shape of the layered film 50A and the positions of the magnets 54 and 55. In the second example, the magnets 54 and 55 are located at positions different from that of the layered film 50A in the Z direction. In particular, in the example shown in FIG. 10, the magnets 54 and 55 are located in front of the layered film 50A in the Z direction. When viewed in the Z direction, the layered film 50A has a rectangular planar shape long in the Y direction. When viewed in the Z direction, the magnets 54 and 55 are located to overlap the layered film 50A.

The direction of the bias magnetic field and the layout of the magnets 54 and 55 are not limited to the examples shown in FIGS. 9 and 10. For example, the direction of the bias magnetic field may be a direction intersecting the direction parallel to the X direction and the direction parallel to the Z direction, and may be a direction oblique to the Y direction. The magnets 54 and 55 may be located at respective different positions in the direction parallel to the X direction.

The bias magnetic field may be applied to the free layer 53 by uniaxial magnetic anisotropy such as magnetic shape anisotropy or magnetocrystalline anisotropy instead of the bias magnetic field generator 50B.

Next, a method for generating the detection value Vs of the present example embodiment will be described. For example, the detection value generation circuit 4 generates the detection value Vs in the following manner. The detection value generation circuit 4 first performs predetermined correction processing on each of the first and second detection signals S1 and S2. The correction processing includes at least processing of setting a phase difference between the first detection signal S1 and the second detection signal S2 to be 90°. The correction processing may further include at least one of processing of correcting an amplitude of each of the first and second detection signals S1 and S2 and processing of correcting an offset of each of the first and second detection signals S1 and S2. The detection value generation circuit 4 then determines an initial detection value in the range of 0° or more and less than 360° by calculating the arctangent of the ratio of the second detection signal S2 to the first detection signal S1, i.e., atan (S2/S1). The initial detection value may be the value of the arctangent itself. The initial detection value may be a value obtained by adding a predetermined angle to the value of the arctangent.

If the foregoing value of the arctangent is 0°, the position of an S pole of the magnetic field generator 3 and the position of the element group 31 in each of the first and third resistors R11 and R13 coincide when viewed from the Z direction. If the foregoing value of the arctangent is 180°, the position of an N pole of the magnetic field generator 3 and the position of the element group 31 in each of the first and third resistors R11 and R13 coincide when viewed from the Z direction. Therefore, the initial detection value has a correspondence with the rotation position of the magnetic field generator 3 within a range from one S pole to another S pole adjoining via one N pole.

The detection value generation circuit 4 also counts the number of rotations of the electrical angle from a reference position, with one period of the initial detection value as an electrical angle of 360°. The electrical angle has a correspondence with the rotation position of the magnetic field generator 3, and one rotation of the electrical angle corresponds to the amount of movement from one S pole to another S pole adjoining via one N pole. The detection value generation circuit 4 generates the detection value Vs having a correspondence with the rotation position of the magnetic field generator 3 on the basis of the initial detection value and the number of rotations of the electrical angle.

Next, a manufacturing method for the magnetic sensor 2 according to the present example embodiment will be briefly described. The manufacturing method for the magnetic sensor 2 includes a step of forming the plurality of MR elements 50 on the substrate 10, a step of forming the terminals 11 to 14 on the substrate 10, and a step of forming a plurality of wiring connected to the plurality of MR elements 50 and the terminals 11 to 14.

In the step of forming the plurality of MR elements 50, a plurality of initial MR elements to later become the plurality of MR elements 50 are initially formed. Each of the plurality of initial MR elements includes an initial magnetization pinned layer to later become the magnetization pinned layer 51, the free layer 53, and the gap layer 52.

Next, the magnetization directions of the initial magnetization pinned layers are fixed to predetermined directions using laser light and external magnetic fields in the foregoing predetermined directions. For example, a plurality of initial MR elements to later become the plurality of MR elements 50 constituting the first, fourth, sixth, and seventh resistors R11, R14, R22, and R23 are irradiated with laser light while an external magnetic field in the first magnetization direction (−X direction) is applied thereto. When the irradiation with the laser light is completed, the magnetization directions of the initial magnetization pinned layers are fixed to the first magnetization direction. This makes the initial magnetization pinned layers into the magnetization pinned layers 51, and the plurality of initial MR elements into the plurality of MR elements 50 constituting the first, fourth, sixth, and seventh resistors R11, R14, R22, and R23.

In a plurality of other initial MR elements to later become the plurality of MR elements 50 constituting the second, third, fifth, and eighth resistors R12, R13, R21, and R24, the magnetization direction of the initial magnetization pinned layer in each of the plurality of other initial MR elements can be fixed to the second magnetization direction (X direction) by setting the direction of the external magnetic field to the second magnetization direction. The plurality of MR elements 50 are formed in such a manner.

Next, the operation and effects of the magnetic encoder 1 according to the present example embodiment will be described. In the present example embodiment, the first to eighth resistors R11 to R14 and R21 to R24 are configured to reduce at least a harmonic component corresponding to a second-order harmonic among a plurality of harmonic components. Specifically, the first to eighth resistors R11 to R14 and R21 to R24 are arranged to satisfy the requirement about the layout in the circuit configuration, the requirement about the physical layout, and the requirement about the magnetization of the magnetization pinned layer as described above. In this way, according to the present example embodiment, an error due to a difference between the magnetic pole pitch λm of the magnetic field generator 3 and the design pitch λs of the magnetic sensor 2 can be reduced.

In comparison with a magnetic encoder of a comparative example, the effects of the magnetic encoder 1 according to the present example embodiment will be described below. Initially, the configuration of the magnetic encoder of the comparative example will be described. The configuration of the magnetic encoder of the comparative example is different from the configuration of the magnetic encoder 1 according to the present example embodiment in a point that a magnetic sensor 102 of the comparative example is provided instead of the magnetic sensor 2 according to the present example embodiment.

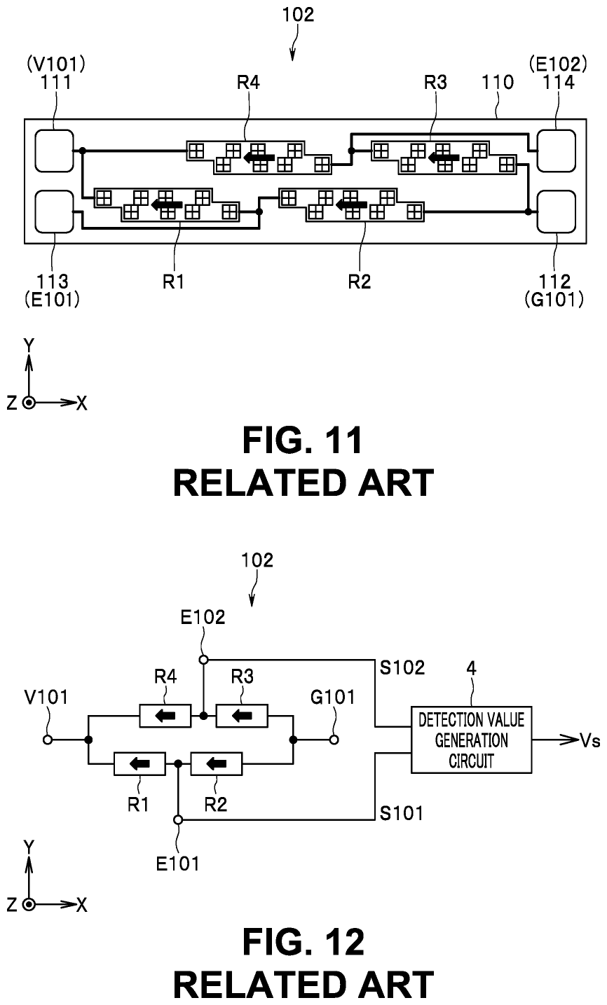

FIG. 11 is a plan view showing the magnetic sensor 102 of the comparative example. FIG. 12 is a circuit diagram showing the configuration of the magnetic sensor 102 of the comparative example. The magnetic sensor 102 includes a first resistor R1, a second resistor R2, a third resistor R3, and a fourth resistor R4 each configured to change in resistance with the strength of the magnetic field component MFx. The magnetic sensor 102 includes the plurality of MR elements 50. Each of the first to fourth resistors R1 to R4 is formed of the plurality of MR elements 50.

The magnetic sensor 102 further includes a power supply port V101, a ground port G101, a first output port E101, and a second output port E102. The ground port G101 is connected to the ground. The first and second output ports E101 and E102 are connected to the detection value generation circuit 4.

The magnetic sensor 102 generates a signal having a correspondence with the potential at the first output port E101 as a first detection signal S101, and generates a signal having a correspondence with the potential at the second output port E102 as a second detection signal S102. The detection value generation circuit 4 connected to the magnetic sensor 102 generates the detection value Vs on the basis of the first and second detection signals S101 and S102.

The first resistor R1 is provided in a path that connects the power supply port V101 and the first output port E101. The second resistor R2 is provided in a path that connects the ground port G101 and the first output port E101. The third resistor R3 is provided in a path that connects the ground port G101 and the second output port E102. The fourth resistor R4 is provided in a path that connects the power supply port V101 and the second output port E102.

The center of gravity of the second resistor R2 when viewed in the Z direction is located at a position λs/2 in the X direction away from the center of gravity of the first resistor R1 when viewed in the Z direction. The center of gravity of the third resistor R3 when viewed in the Z direction is located at a position λs/2 in the X direction away from the center of gravity of the fourth resistor R4 when viewed in the Z direction. The center of gravity of the fourth resistor R4 when viewed in the Z direction is located at a position λs/4 in the X direction away from the center of gravity of the first resistor R1 when viewed in the Z direction.

In FIGS. 11 and 12, arrows shown inside the first to fourth resistors R1 to R4 indicate first magnetization directions of magnetization pinned layers in the respective plurality of MR elements 50 included in the resistors. In the comparative example, the first magnetization directions are the −X direction in all of the first to fourth resistors R1 to R4.

Each of the first to fourth resistors R1 to R4 includes a plurality of element groups. The configuration and layout of the plurality of element groups in each of the first to fourth resistors R1 to R4 are the same as those of the plurality of element groups in the first resistor R11 of the magnetic sensor 2 according to the present example embodiment.

Next, the first detection signal S101 in the comparative example will be described. In the comparative example, a resistance R₁ of the first resistor R1 and a resistance R₂ of the second resistor R2 are represented in the following equations (1) and (2), respectively. Note that, in the equations (1) and (2), R₀ and ΔR are each a predetermined constant, and θ represents an electrical angle.

R₁=R₀+ΔR cos(θ) (1)

R₂=R₀+ΔR cos(θ+λs/λm×π) (2)

The first detection signal S101 is represented in the following equation (3).

S101=R₂/(R₁+R₂) (3)

When the magnetic pole pitch λm is equal to the design pitch λs, the first detection signal S101 is represented in the following equation (4) from the equations (1) to (3).

$$S 101 = {R}_{2} / ( 2 {R}_{0} + Δ R cos ( θ ) - Δ R cos ( θ ) ) = {R}_{2} / 2 {R}_{0} \qquad ( 4 )$$

When the magnetic pole pitch λm is different from the design pitch λs, the first detection signal S101 is represented in the following equation (5) from the equations (1) to (3).

S101=R₂/(2R₀+ΔR cos(θ)+ΔR cos(θ+λs/λm×π)) (5)

As can be seen from the equation (4), when the magnetic pole pitch λm is equal to the design pitch λs, the first detection signal S101 is equal to a constant number of times R₂. In this case, it is ideal that the first detection signal S101 periodically varies so as to trace an ideal sinusoidal curve according to the electrical angle θ (see the equation (2)). On the other hand, as can be seen from the equation (5), when the magnetic pole pitch λm is different from the design pitch λs, a component that changes according to the electrical angle θ is included in a denominator in the equation (5). The component causes the first detection signal S101 to generate a harmonic component corresponding to a second-order harmonic.

The description of the first detection signal S101 also applies to the second detection signal S102. A resistance R3 of the third resistor R3, a resistance R4 of the fourth resistor R4, and the second detection signal S102 can each be represented by using a sine function that changes according to the electrical angle θ. When the magnetic pole pitch km is different from the design pitch λs, a harmonic component corresponding to a second-order harmonic is also generated in the second detection signal S102. The harmonic component of each of the first and second detection signals S101 and S102 causes an error in the detection value Vs.

Next, the first detection signal S1 in the present example embodiment will be described. In the present example embodiment, a resistance Ru of the first resistor R11, a resistance R12 of the second resistor R12, a resistance R13 of the third resistor R13, and a resistance R14 of the fourth resistor R14 are represented in the following equations (6) to (9), respectively.

$${R}_{11} = {R}_{0} + Δ R cos ( θ ) \qquad ( 6 )$$

$${R}_{12} = {R}_{0} + Δ R cos ( θ + λ s / λ m \times π + π ) = {R}_{0} - Δ R cos ( θ + λ s / λ m \times π ) \qquad ( 7 )$$

$${R}_{13} = {R}_{0} + Δ R cos ( θ + π ) = {R}_{0} - Δ R cos ( θ + π ) \qquad ( 8 )$$

$${R}_{14} = {R}_{0} + Δ R cos ( θ + λ s / λ m \times π ) \qquad ( 9 )$$

The first detection signal S1 is represented in the following equation (10).

$$S 1 = ( {R}_{13} + {R}_{14} ) / ( {R}_{11} + {R}_{12} + {R}_{13} + {R}_{14} ) = ( {R}_{13} + {R}_{14} ) / 4 {R}_{0} \qquad ( 10 )$$

As can be seen from the equation (10), in the present example embodiment, regardless of whether the magnetic pole pitch λm is equal to the design pitch λs, the denominator in the equation (10) is a constant, and the first detection signal S1 is equal to a constant number of times of a sum of the resistance R₁₃ and the resistance R₁₄. Therefore, in the present example embodiment, it is ideal that the first detection signal S1 periodically varies so as to trace an ideal sinusoidal curve according to the electrical angle θ regardless of whether the magnetic pole pitch λm is equal to the design pitch λs (see the equations (8) and (9)).

The description of the first detection signal S1 also applies to the second detection signal S2. The second detection signal S2 is represented in an equation in which R₁₁, R₁₂, R₁₃, and R₁₄ in the equation (10) are replaced with a resistance R₂₁ of the fifth resistor R21, a resistance R22 of the sixth resistor R22, a resistance R23 of the seventh resistor R23, and a resistance R24 of the eighth resistor R24, respectively. Similarly to the first detection signal S1, it is ideal that the second detection signal S2 periodically varies so as to trace an ideal sinusoidal curve according to the electrical angle θ regardless of whether the magnetic pole pitch λm is equal to the design pitch λs.

As described above, the present example embodiment is configured to reduce a harmonic component corresponding to a second-order harmonic among a plurality of harmonic components. In this way, according to the present example embodiment, an error can be prevented from being caused in the detection value Vs. The effect will be described below with reference to a simulation result.

In the simulation, a model of a comparative example and a model of a practical example were used. The model of the comparative example is a model for the magnetic encoder of the comparative example. The model of the practical example is a model for the magnetic encoder 1 according to the present example embodiment.

In the simulation, the design pitch λs was 800 μm. In the model of the comparative example, the first to fourth resistors R1 to R4 were arranged such that the center of gravity of the second resistor R2 was located at a position 400 μm in the X direction away from the center of gravity of the first resistor R1, the center of gravity of the third resistor R3 was located at a position 400 μm in the X direction away from the center of gravity of the fourth resistor R4, and the center of gravity of the fourth resistor R4 was located at a position 200 μm in the X direction away from the center of the gravity of the first resistor R1.

In the model of the practical example, the first to eighth resistors R11 to R14 and R21 to R24 were arranged such that the second position C12 was located at a position 400 μm in the X direction away from the first position C11, the fourth position C14 was located at a position 400 μm in the X direction away from the third position C13, the sixth position C22 was located at a position 400 μm in the X direction away from the fifth position C21, the eighth position C24 was located at a position 400 μm in the X direction away from the seventh position C23, and the fifth position C21 was located at a position 200 μm in the X direction away from the first position C11.

In the simulation, both of a distance between the magnetic sensor 2 and the magnetic field generator 3 in the direction parallel to the Z direction, and a distance between the magnetic sensor 102 and the magnetic field generator 3 in the direction parallel to the Z direction were 0.4 mm. Further, both a voltage applied to the power supply port V1 and a voltage applied to the power supply port V101 were 1 V.

Herein, a component having a signal period that coincides with a signal period of an ideal component is referred to as a first-order component, a harmonic component corresponding to a second harmonic is referred to as a second-order component, a harmonic component corresponding to a third harmonic is referred to as a third-order component, a harmonic component corresponding to a fourth harmonic is referred to as a fourth-order component, a harmonic component corresponding to a fifth harmonic is referred to as a fifth-order component, and a harmonic component corresponding to a sixth harmonic is referred to as a sixth-order component. A ratio of an amplitude of one harmonic component to an amplitude of the first-order component is referred to as an amplitude ratio of the harmonic component. A difference between an initial detection value assumed when each of the detection signals S1, S2, S101, and S102 includes only an ideal component, and an initial detection value acquired from the simulation is referred to as an error of the detection value Vs. Note that the initial detection value is a value corresponding to an electrical angle determined by calculation, and is represented as a value in a range of 0° or more and less than 360°. Therefore, a unit of the error of the detection value Vs is represented by angle.

In the simulation, the magnetic pole pitch λm was changed by 200 μm within a range from 600 μm to 2600 μm. In the model of the comparative example, the first and second detection signals S101 and S102 and the detection value Vs when the magnetic field generator 3 was rotated were obtained for each magnetic pole pitch λm. By performing a Fourier transform on the first detection signal S101, the first-order component to the sixth-order component of the first detection signal S101 were obtained, and an amplitude ratio of each of the second-order component to the sixth-order component was obtained for the first detection signal S101. An error of the detection value Vs was obtained.

Similarly, in the model of the practical example, the first and second detection signals S1 and S2 and the detection value Vs when the magnetic field generator 3 was rotated were obtained for each magnetic pole pitch λm. By performing a Fourier transform on the first detection signal S1, the first-order component to the sixth-order component of the first detection signal S1 were obtained, and an amplitude ratio of each of the second-order component to the sixth-order component was obtained for the first detection signal S1. An error of the detection value Vs was obtained.

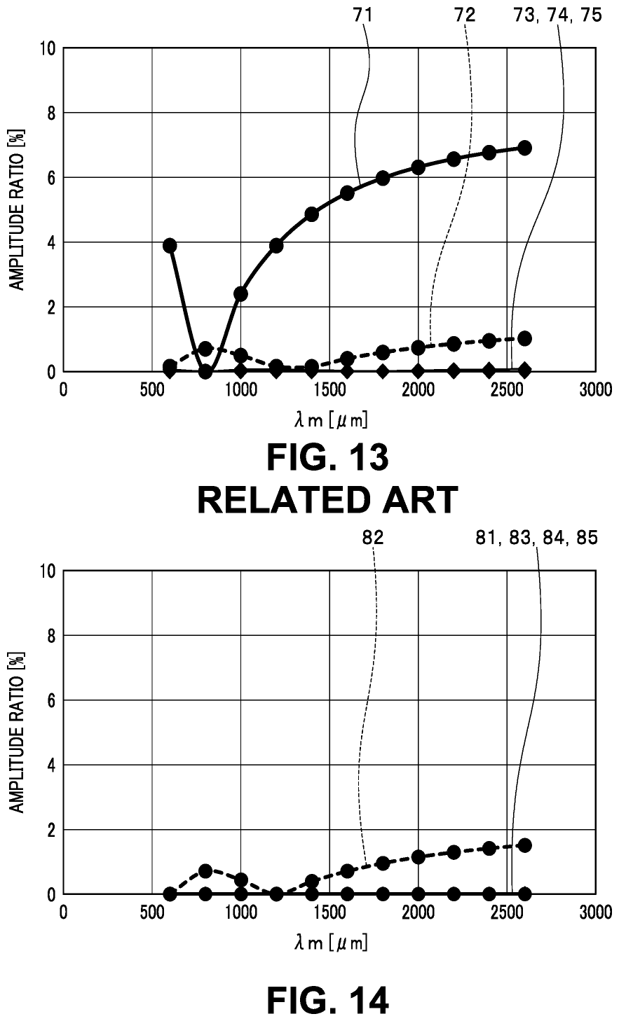

FIG. 13 is a characteristic chart showing an amplitude ratio of the model of the comparative example determined by the simulation. FIG. 14 is a characteristic chart showing an amplitude ratio of the model of the practical example determined by the simulation. In FIGS. 13 and 14, a horizontal axis represents the magnetic pole pitch λm, and a vertical axis represents an amplitude ratio. In FIG. 13, a reference numeral 71 denotes an amplitude ratio of the second-order component, a reference numeral 72 denotes an amplitude ratio of the third-order component, a reference numeral 73 denotes an amplitude ratio of the fourth-order component, a reference numeral 74 denotes an amplitude ratio of the fifth-order component, and a reference numeral 75 denotes an amplitude ratio of the sixth-order component. In FIG. 14, a reference numeral 81 denotes an amplitude ratio of the second-order component, a reference numeral 82 denotes an amplitude ratio of the third-order component, a reference numeral 83 denotes an amplitude ratio of the fourth-order component, a reference numeral 84 denotes an amplitude ratio of the fifth-order component, and a reference numeral 85 denotes an amplitude ratio of the sixth-order component.

As shown in FIG. 13, in the model of the comparative example, the amplitude ratio (reference numeral 73) of the fourth-order component, the amplitude ratio (reference numeral 74) of the fifth-order component, and the amplitude ratio (reference numeral 75) of the sixth-order component were zero or substantially zero. In the model of the comparative example, except when the magnetic pole pitch λm was 800 μm, it was clear that the amplitude ratio (reference numeral 71) of the second-order component was the greatest. It was clear that the amplitude ratio (reference numeral 71) of the second-order component was minimum when the magnetic pole pitch λm was 800 μm, and increased as the magnetic pole pitch λm increased from 800 μm. Note that the case where the magnetic pole pitch λm is 800 μm is a case where the magnetic pole pitch λm is equal to the design pitch λs.

As shown in FIG. 14, in the model of the practical example similarly to the model of the comparative example, the amplitude ratio (reference numeral 83) of the fourth-order component, the amplitude ratio (reference numeral 84) of the fifth-order component, and the amplitude ratio (reference numeral 85) of the sixth-order component were zero or substantially zero. In the model of the practical example, the amplitude ratio (reference numeral 81) of the second-order component was zero.

The results shown in FIGS. 13 and 14 also apply to the second detection signals S2 and S102. It is clear from the simulation results that the present example embodiment is configured to reduce a harmonic component (second-order component) corresponding to a second-order harmonic among a plurality of harmonic components.

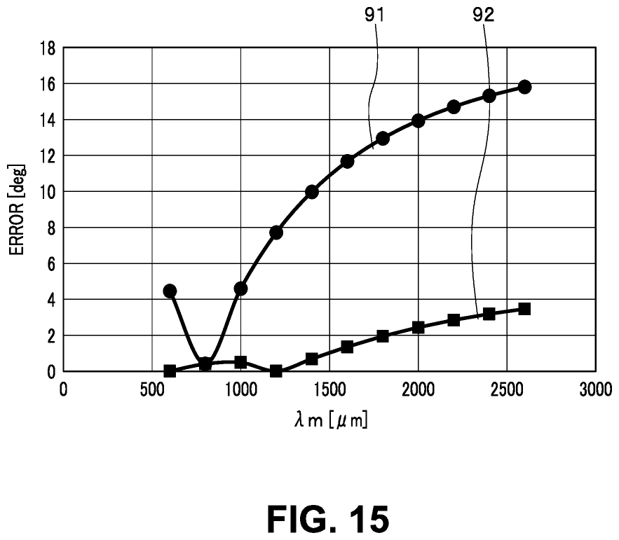

FIG. 15 is a characteristic chart showing an error of the detection value Vs of each of the model of the comparative example and the model of the practical example determined by the simulation. In FIG. 15, a horizontal axis represents the magnetic pole pitch λm, and a vertical axis represents an error of the detection value Vs. In FIG. 15, a reference numeral 91 denotes an error of the model of the comparative example, and a reference numeral 92 denotes an error of the model of the practical example.

As described above, in the simulation, the error of the detection value Vs was calculated by using an initial detection value, and the initial detection value was calculated by using the detection signals S1, S2, S101, and S102. A waveform of each of the detection signals S1, S2, S101, and S102 was distorted from a sinusoidal curve depending on an amplitude ratio of a harmonic component. Therefore, the error of the detection value Vs depended on the amplitude ratio of the harmonic component. As can be seen from FIGS. 13 to 15, in the model of the comparative example, the error (reference numeral 91 in FIG. 15) of the detection value Vs greatly depended on the amplitude ratio (reference numeral 71 in FIG. 13) of the second-order component. Similarly to the amplitude ratio of the second-order component, the error of the detection value Vs was minimum when the magnetic pole pitch λm was equal to the design pitch λs (800 μm), and increased as the magnetic pole pitch λm increased from 800 μm, in other words, a divergence of the magnetic pole pitch λm from the design pitch λs increased.

As can be seen from FIGS. 14 and 15, in the model of the practical example, since the amplitude ratio (reference numeral 81 in FIG. 14) of the second-order component was zero, the error (reference numeral 92 in FIG. 15) of the detection value Vs greatly depended on the amplitude ratio (reference numeral 82 in FIG. 14) of the third-order component. However, the amplitude ratio (reference numeral 82 in FIG. 14) of the third-order component in the model of the practical example was sufficiently smaller than the amplitude ratio (reference numeral 71 in FIG. 13) of the second-order component in the model of the comparative example. Thus, as shown in FIG. 15, the error (reference numeral 92) in the model of the practical example was sufficiently smaller than the error (reference numeral 91) in the model of the comparative example.

As can be seen from the simulation results, according to the present example embodiment, an error due to a difference between the magnetic pole pitch λm and the design pitch λs can be prevented from being caused in the detection value Vs by a means configured to reduce a harmonic component (second-order component) corresponding to a second-order harmonic among a plurality of harmonic components.

As described above, in the present example embodiment, the element groups 31 to 38 are located to reduce a harmonic component corresponding to a third-order harmonic, a harmonic component corresponding to a fifth-order harmonic, and a harmonic component corresponding to a seventh-order harmonic. In other words, in the present example embodiment, the first to eighth resistors R11 to R14 and R21 to R24 are configured to reduce the harmonic components corresponding to the third-order, fifth-order, and seventh-order harmonics in addition to the harmonic component corresponding to the second-order harmonic. In this way, according to the present example embodiment, the error of the detection value Vs can be further reduced.

When the magnetic encoder 1 is applied to a device that generates a relatively great vibration, a great distance between the magnetic sensor 2 and the magnetic field generator 3 may be required in order to prevent a collision between the magnetic sensor 2 and the magnetic field generator 3. In this case, the magnetic pole pitch λm is preferably greater than the design pitch λs in order to set, as desired magnitude, the strength of the magnetic field component MFx (see FIG. 4) at a position where the magnetic sensor 2 is located. Specifically, the magnetic pole pitch λm is preferably greater than 1.1 times the design pitch λs and greater than 1.25 times the design pitch λs. On the other hand, as can be seen from FIG. 15, when the magnetic pole pitch λm is 1400 μm or more, in other words, the magnetic pole pitch λm is 1.75 times or more the design pitch λs, the error of the detection value Vs increases as the magnetic pole pitch λm increases. Thus, the magnetic pole pitch λm is preferably smaller than 1.75 times the design pitch λs.

### Modification Example

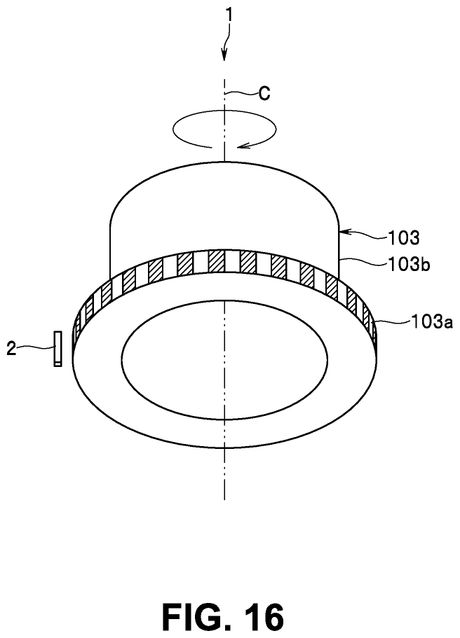

Next, a modification example of the magnetic encoder 1 according to the present example embodiment will be described with reference to FIG. 16. FIG. 16 is a perspective view showing the modification example of the magnetic encoder 1. In the modification example, the magnetic encoder 1 includes a magnetic field generator 103 instead of the magnetic field generator 3 shown in FIGS. 2 and 3. The magnetic field generator 103 includes outer circumferential surfaces 103a and 103b each directed to a direction away from the rotation axis C. The outer circumferential surfaces 103a and 103b are located in positions different from each other in the direction parallel to the rotation axis C. The outer circumferential surface 103a is located at a position away from the rotation axis C farther than the outer circumferential surface 103b.

The plurality of pairs of N and S poles are provided on the outer circumferential surface 103a. In FIG. 16, for ease of understanding, the N pole is shown with hatching. The magnetic sensor 2 is located so as to face the outer circumferential surface 103a. The strength of the magnetic field component MFx (see FIG. 4) in a reference position, for example, a position in which the magnetic sensor 2 is located changes according to rotation of the magnetic field generator 103.

In the modification example, a direction parallel to the rotation axis C may be the Y direction, and a direction orthogonal to the rotation axis C and directed from the magnetic sensor 2 to the rotation axis C may be the Z direction.

The technology is not limited to the foregoing example embodiments, and various modifications may be made thereto. For example, the number and layout of the MR elements 50 are not limited to the examples described in the example embodiments but may be freely set as long as the requirements set forth in the claims are satisfied.

Each of the first to eighth positions C11 to C14 and C21 to C24 may be a position other than the center of gravity, such as an end portion of a corresponding resistor in the −X direction.

The third, fourth, seventh, and eighth resistors R13, R14, R23, and R24 may be located at positions an integral number of times of the design pitch λs away from the first, second, fifth, and sixth resistors R11, R12, R21, and R22 in the X direction or the —X direction, respectively.

The magnetic field generator according to the technology may be a linear scale magnetized to a plurality of pairs of N and S poles in a linear direction. In this case, the magnetic encoder according to the technology may be applied to a position detection device for detecting a position of a target object whose position can be changed. The magnetic sensor and the magnetic field generator may be configured such that the strength of the magnetic field component changes with a change in the position of the target object.

The magnetic sensor according to the technology may include a first full bridge circuit configured to output a first detection signal, and a second full bridge circuit configured to output a second detection signal. Each of the first and second full bridge circuits may be formed of a plurality of resistors.

Obviously, many modifications and variations of the technology are possible in the light of the above teachings. Thus, it is to be understood that, within the scope of the appended claims and equivalents thereof, the technology may be practiced in other example embodiments than the foregoing example embodiment.

What is claimed is:

1. A magnetic encoder comprising:
a magnetic field generator configured to generate a target magnetic field including a magnetic field component in a first direction; and
a magnetic sensor configured to detect the target magnetic field, wherein
the magnetic sensor and the magnetic field generator are configured such that strength of the magnetic field component in a reference position changes when at least one of the magnetic sensor and the magnetic field generator operates,
the magnetic field generator is a magnetic scale including a plurality of pairs of N and S poles alternately arranged,
the magnetic sensor includes a plurality of resistors each configured to change in resistance with change in the strength of the magnetic field component, and is configured to generate a first detection signal and a second detection signal each corresponding to change in the strength of the magnetic field component,
the plurality of resistors include two resistors,
a resistance of one resistor of the two resistors has a correspondence with the first detection signal,
a resistance of another resistor of the two resistors has a correspondence with the second detection signal,
the one resistor and the other resistor are arranged in positions different from each other in the first direction such that a phase of the first detection signal and a phase of the second detection signal are different from each other,
when a magnetic pole pitch refers to a center-to-center distance between two N poles adjoining via one S pole in the magnetic scale, and a design pitch refers to four times a distance between a predetermined position in the one resistor and a predetermined position in the other resistor in the first direction, the magnetic pole pitch is greater than the design pitch,
each of the first and second detection signals contains an ideal component that varies periodically so as to trace an ideal sinusoidal curve, and a plurality of harmonic components each corresponding to a higher-order harmonic of the ideal component, and
the plurality of resistors are configured to reduce at least a harmonic component corresponding to a second-order harmonic among the plurality of harmonic components.

2. The magnetic encoder according to claim 1, wherein the magnetic pole pitch is greater than 1.1 times the design pitch.

3. The magnetic encoder according to claim 2, wherein the magnetic pole pitch is greater than 1.25 times the design pitch and smaller than 1.75 times the design pitch.

4. The magnetic encoder according to claim 1, wherein:
the magnetic sensor further includes
a power supply port,
a ground port,
a first output port, and
a second output port;
the plurality of resistors include a first resistor, a second resistor, a third resistor, a fourth resistor, a fifth resistor, a sixth resistor, a seventh resistor, and an eighth resistor;
the first resistor and the second resistor are provided in this order from a side of the power supply port in a first path that connects the power supply port and the first output port;
the third resistor and the fourth resistor are provided in this order from a side of the ground port in a second path that connects the ground port and the first output port;
the fifth resistor and the sixth resistor are provided in this order from a side of the ground port in a third path that connects the ground port and the second output port;
the seventh resistor and the eighth resistor are provided in this order from a side of the power supply port in a fourth path that connects the power supply port and the second output port;
a distance between a first position in the first resistor and a second position in the second resistor in the first direction, a distance between a third position in the third resistor and a fourth position in the fourth resistor in the first direction, a distance between a fifth position in the fifth resistor and a sixth position in the sixth resistor in the first direction, and a distance between a seventh position in the seventh resistor and an eighth position in the eighth resistor in the first direction are each equal to an odd number of times ½ of the design pitch;
a distance between the first position and the third position in the first direction and a distance between the fifth position and the seventh position in the first direction are each equal to zero or an integral number of times of the design pitch;
a distance between the first position and the fifth position in the first direction is equal to ¼ of the design pitch;
the magnetic sensor further includes a plurality of magnetoresistive elements;
each of the plurality of magnetoresistive elements includes a magnetization pinned layer, a free layer, and a gap layer located between the magnetization pinned layer and the free layer;
the magnetization pinned layer has a first magnetization whose direction is fixed;
the free layer has a second magnetization whose direction is variable within a plane parallel to both of the first direction and a second direction orthogonal to the first direction;
the magnetization pinned layer, the free layer, and the gap layer are stacked in a third direction orthogonal to the first direction and the second direction;
the first to eighth resistors are formed of the plurality of magnetoresistive elements;
the first magnetization of the magnetization pinned layer in the first, fourth, sixth, and seventh resistors contains a component in a first magnetization direction being one direction parallel to the first direction; and
the first magnetization of the magnetization pinned layer in the second, third, fifth, and eighth resistors contains a component in a second magnetization direction opposite to the first magnetization direction.

5. The magnetic encoder according to claim 4, wherein:
the first position is a center of gravity of the first resistor when viewed in one direction parallel to the third direction;
the second position is a center of gravity of the second resistor when viewed in one direction parallel to the third direction;
the third position is a center of gravity of the third resistor when viewed in one direction parallel to the third direction;
the fourth position is a center of gravity of the fourth resistor when viewed in one direction parallel to the third direction;
the fifth position is a center of gravity of the fifth resistor when viewed in one direction parallel to the third direction;
the sixth position is a center of gravity of the sixth resistor when viewed in one direction parallel to the third direction;
the seventh position is a center of gravity of the seventh resistor when viewed in one direction parallel to the third direction; and
the eighth position is a center of gravity of the eighth resistor when viewed in one direction parallel to the third direction.

6. The magnetic encoder according to claim 4, wherein:
the first resistor and the third resistor adjoin in the second direction;
the second resistor and the fourth resistor adjoin in the second direction;
the fifth resistor and the seventh resistor adjoin in the second direction; and
the sixth resistor and the eighth resistor adjoin in the second direction.

7. The magnetic encoder according to claim 4, wherein:
the first resistor adjoins to the seventh resistor and does not adjoin to the eighth resistor; and
the eighth resistor adjoins to the second resistor and does not adjoin to the first resistor.

8. The magnetic encoder according to claim 7, wherein:
the third resistor is located at a position such that the first resistor is sandwiched between the third resistor and the seventh resistor;
the fourth resistor is located at a position such that the second resistor is sandwiched between the fourth resistor and the eighth resistor;
the fifth resistor is located at a position such that the seventh resistor is sandwiched between the fifth resistor and the first resistor; and
the sixth resistor is located at a position such that the eighth resistor is sandwiched between the sixth resistor and the second resistor.

9. The magnetic encoder according to claim 4, wherein each of the plurality of magnetoresistive elements is configured such that a bias magnetic field in a direction intersecting the first direction is applied to the free layer.

10. The magnetic encoder according to claim 4, wherein the gap layer is a tunnel barrier layer.

11. The magnetic encoder according to claim 1, wherein:
the magnetic field generator is configured to rotate about a rotation axis, and includes an end surface located at an end in one direction parallel to the rotation axis;
the plurality of pairs of N and S poles are alternately arranged around the rotation axis, and are provided on the end surface;
the strength of the magnetic field component in the reference position changes according to rotation of the magnetic field generator; and
the magnetic sensor is located to face the end surface.

12. The magnetic encoder according to claim 11, wherein the magnetic field generator is configured to rotate in conjunction with an optical element configured to change a traveling direction of light for measuring a distance to a target object.

13. The magnetic encoder according to claim 1, wherein:
the magnetic field generator is configured to rotate about a rotation axis, and includes an outer circumferential surface directed to a direction away from the rotation axis;
the plurality of pairs of N and S poles are alternately arranged around the rotation axis, and are provided on the outer circumferential surface;
the strength of the magnetic field component in the reference position changes according to rotation of the magnetic field generator; and
the magnetic sensor is located to face the outer circumferential surface.

14. The magnetic encoder according to claim 13, wherein the magnetic field generator is configured to rotate in conjunction with an optical element configured to change a traveling direction of light for measuring a distance to a target object.

15. A distance measuring device for measuring a distance to a target object by detecting applied light, the distance measuring device comprising:
an optical element configured to rotate together when a traveling direction of the light changes; and
the magnetic encoder according to claim 1; wherein
the magnetic field generator is configured to rotate about a rotation axis in conjunction with the optical element,
the plurality of pairs of N and S poles are alternately arranged around the rotation axis, and
the strength of the magnetic field component in the reference position changes according to rotation of the magnetic field generator.

16. The distance measuring device according to claim 15, wherein:
the magnetic field generator includes an end surface located at an end in one direction parallel to the rotation axis;
the plurality of pairs of N and S poles are provided on the end surface; and
the magnetic sensor is located to face the end surface.

17. The distance measuring device according to claim 15, wherein:
the magnetic field generator includes an outer circumferential surface directed to a direction away from the rotation axis;
the plurality of pairs of N and S poles are provided on the outer circumferential surface; and
the magnetic sensor is located to face the outer circumferential surface.
